(19) United States
(12) Patent Application Publication
(10) Pub. No.: US 2023/0139761 A1
(43) Pub. Date: May 4, 2023

(54) METHOD FOR PROVIDING USER-INTERFACE FOR MULTI-PARTY SCHEDULE MANAGING AND SERVER PERFORMING THE SAME

(71) Applicants: Nam Hae CHO, Seoul (KR); Ik Hee Ryu, Seoul (KR)

(72) Inventors: Nam Hae CHO, Seoul (KR); Ik Hee Ryu, Seoul (KR)

(21) Appl. No.: 17/975,303

(22) Filed: Oct. 27, 2022

(30) Foreign Application Priority Data
Oct. 29, 2021 (KR) 10-2021-0146843

(51) Int. Cl. G06Q 10/10

(52) U.S. Cl. CPC G06Q 10/1093

(57) ABSTRACT

The present disclosure is a user interface providing method for multi-party schedule management including transmitting, by the processor, a schedule management interface in which individual schedules of a plurality of users are arranged to a user device through a communication interface connected thereto, receiving, by the processor, a schedule registration request related to a first user among the plurality of users obtained from the schedule management interface through the communication interface, from the user device, determining, by the processor, a second user who is available for schedule registration, among the plurality of users, according to a type of the scheduler registration request and registering, by the processor, a cooperative schedule including the first user and the determined second user in the schedule management interface output through the display of the user device.

### CROSS-REFERENCE TO RELATED APPLICATIONS

This application claims the priority of Korean Patent Application No. 10-2021-0146843 filed on Oct. 29, 2021, in the Korean Intellectual Property Office, the disclosure of which is incorporated herein by reference.

### BACKGROUND

### Field

The present disclosure relates to a user-interface providing method for multi-party schedule management and a server performing the same.

### Description of the Related Art

Recently, in accordance with rapid increase of a distribution rate of smart devices such as smart phones or smart watches, efforts to develop various and convenient applications corresponding to this are also accelerating.

Typically, demands for schedule management applications have continued from numerous people who are pressed for time in a busy life. In response to this demand, various applications for managing their schedule using smart devices have been developed and distributed.

As one of schedule management applications of the related art, an application displaying schedules of users using a calendar type user interface has been proposed.

The schedule management applications of the related art were able to intuitively check and individual's schedule and easily manage it. However, since numerous schedules of a plurality of users are not intuitively displayed so that there is a problem in that usability of users who manage schedules in the unit of groups is greatly reduced.

The background of the present disclosure is described for easier understanding of the present disclosure. It should not be understood to admit the matters described in the background of the present disclosure as a prior art.

### SUMMARY

Therefore, in order to manage multi-party schedules, a new schedule management user interface that intuitively checks schedules of users in a group and manages the schedule to allow two or more users to share any one common schedule is demanded.

As a result, inventors of the present disclosure have tried to develop a method of arranging schedules of users in individual schedule regions, searching for users who can deal with the schedule when a schedule that requires two or more users is registered, and planning the schedule and a server performing the same.

Objects of the present disclosure are not limited to the above-mentioned objects, and other objects, not mentioned above, can be clearly understood by those skilled in the art from the following descriptions.

In order to achieve the above-described objects, according to an aspect of the present disclosure, a user interface providing method for multi-party schedule management includes: generating, by a processor, a schedule management interface in which individual schedules of a plurality of users are respectively arranged according to schedule regions, transmitting, by the processor, a schedule management interface to a user device through a communication interface connected to the user device; receiving, by the processor, a schedule registration request related to a first user among the plurality of users obtained from the schedule management interface through the communication interface, from the user device; determining, by the processor, a second user who is available for the schedule registration, among the plurality of users, according to a type of the scheduler registration request; registering, by the processor, a cooperative schedule including the first user and the determined second user in the schedule management interface; and outputting the schedule management interface through a display of the user device.

According to a feature of the present disclosure, the schedule management interface, includes the schedule region of each of the plurality of users and an individual schedule disposed in the schedule region, and wherein, as the cooperative schedule, a performance schedule of the first user or a participation schedule of the second user may be arranged in the schedule regions of the first and second users.

According to another feature of the present disclosure, the participation schedule of the second user may overlap a predetermined time interval of the performance schedule of the first user based on the schedule.

According to still another feature of the present disclosure, in the schedule management interface, a start point of the participation schedule in a schedule region of the second user is disposed to be equal to a start point of the performance schedule in the schedule region of the first user or an end point of the participation schedule in the schedule region of the second user may be disposed to be equal to an end point of the performance schedule in the schedule region of the first user.

According to still another feature of the present disclosure, in the schedule management interface, a schedule including two or more users may be displayed by different images based on a moving means for the schedule or the user included in the schedule.

According to still another feature of the present disclosure, the schedule management interface, displays a schedule related notification designated by a schedule registration user on the individual schedule.

According to still another feature of the present disclosure, the schedule registration request includes at least one schedule performing item, among a start time, an end time, a start location, an arrival location, and moving means of the schedule and the determining of a user may be a step of determining, by the processor, a user available for the schedule registration based on the schedule performance item.

According to still another feature of the present disclosure, the method may further include transmitting, by the processor, a list for selecting a user who is available for the schedule registration to the user device through the communication interface when there are two or more users who are available for the schedule registration.

According to still another feature of the present disclosure, the determining of a user may further include checking, by the processor, a location of each of the plurality of users based on the individual schedules and determining, by the processor, whether each of the plurality of users is available for the schedule registration based on the checked location.

According to still another feature of the present disclosure, the receiving of a schedule registration request further includes transmitting, by the processor, a schedule registration interface to the user device through the communication interface, and the schedule registration interface may include an input region of a first user who performs the schedule and a schedule category selection region.

According to still another feature of the present disclosure, the receiving of a schedule registration request may further include determining, by the processor, whether a second user is necessary depending on a type of the schedule category.

According to still another feature of the present disclosure, the method may further include receiving, by the processor, a schedule related to any one user among the plurality of users from a third-party device through the communication interface and receiving, by processor, whether the schedule is confirmed from the user device of the corresponding user through the communication interface, registering, by the processor, the confirmed schedule in the schedule management interface.

According to still another feature of the present disclosure, the registering in the schedule management interface may further include transmitting, by the processor, a schedule registration notification to each of user devices of two or more users through the communication interface.

In order to achieve the above-described objects, according to another aspect of the present disclosure, a user interface providing server for multi-party schedule management includes a communication interface, a memory, and a processor that is operably connected to the communication interface and the memory, and the processor is configured to generate a schedule management interface in which individual schedules of a plurality of users are respectively arranged according to schedule regions, transmit a schedule management interface to a user device through a communication interface connected to the user device, receive a schedule registration request related to a first user among the plurality of users obtained from the schedule management interface through the communication interface, from the user device, determine a second user who is available for the schedule registration, among the plurality of users, according to a type of the scheduler registration request, register a cooperative schedule including the first user and the determined second user in the schedule management interface, and output the schedule management interface through a display of the user device.

Other detailed matters of the exemplary embodiments are included in the detailed description and the drawings.

According to the present disclosure, it is possible to intuitively check the multi-party schedule so that a schedule that two or more users need to participate may be more conveniently managed.

According to the present disclosure, when a schedule requiring two or more users is registered in a user interface, users who can perform the schedule together are determined to be provided so that the schedule may be conveniently registered.

Further, according to the present disclosure, a location, a departure point, a destination, a moving means, and a distance to perform the schedule are provided through the user interface. Accordingly, it is possible to provide information that allows the user to efficiently plan the schedule may be provided.

Further, according to the present disclosure, users who need helps or give helps may be mediated while performing the schedule management service.

The effects according to the present disclosure are not limited to the content exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic view of a multi-party schedule management system according to an exemplary embodiment of the present disclosure;

FIG. 2 is a block diagram illustrating a configuration of a user device according to an exemplary embodiment of the present disclosure;

FIG. 3 is a block diagram illustrating a configuration of a schedule management server providing a user interface according to an exemplary embodiment of the present disclosure;

FIG. 4 is a flowchart for a user interface providing method according to an exemplary embodiment of the present disclosure; and

FIGS. 5 to 8 are schematic views for explaining a user interface screen for multi-party schedule management according to an exemplary embodiment of the present disclosure.

### DETAILED DESCRIPTION OF THE EMBODIMENT

Advantages and characteristics of the present disclosure and a method of achieving the advantages and characteristics will be clear by referring to exemplary embodiments described below in detail together with the accompanying drawings. However, the present disclosure is not limited to the following exemplary embodiments but may be implemented in various different forms. The exemplary embodiments are provided only to complete the disclosure of the present disclosure and to fully provide a person having ordinary skill in the art to which the present disclosure pertains with the category of the disclosure, and the present disclosure will be defined by the appended claims. In the description of drawings, like reference numerals denote like components.

In this specification, the terms “have”, “may have”, “include”, or “may include” represent the presence of the characteristic (for example, a numerical value, a function, an operation, or a component such as a part”), but do not exclude the presence of additional characteristic.

In the specification, the terms “A or B”, “at least one of A or/and B”, or “at least one or more of A or/and B” may include all possible combinations of enumerated items. For example, the terms “A or B”, “at least one of A or/and B”, or “at least one or more of A or/and B” may refer to an example which includes (1) at least one A, (2) at least one B, or (3) all at least one A and at least one B.

Although the terms “first”, “second”, and the like, may be used herein to describe various components regardless of an order and/or importance, the components are not limited by these terms. These terms are only used to distinguish one component from another. For example, a first user device and a second user device may refer to different user devices regardless of the order or the importance. For example, without departing from the scope of the present disclosure, a first component may be referred to as a second component, and similarly, a second component may be referred to as a first component.

When a component (for example, a first component) is referred to as being “operatively or communicatively coupled with/to” or “connected to” another component (for example, a second component), it can be understood that the component is directly connected to the other element, or connected to the other element via another component (for example, a third component). In contrast, when a component (for example, a first component) is referred to as being “directly coupled with/to” or “connected to” another component (for example, a second component), it is understood that there may be another component (for example, a third component) between the components.

The terms “configured to (or set to)” may be exchangeably used with “suitable for”, “having the capacity to”, “designed to”, “adapted to”, “made to”, or “capable of” depending on the situation. The terms “configured to (or set)” may not necessarily mean only “specifically designed to” in a hardware manner. Instead, in some situation, the terms “a device configured to” may mean that the device is capable of something together with another device or components”. For example, the terms “a processor configured (or set) to perform A, B, and C” may refer to a dedicated processor (for example, an embedded processor) configured to perform the corresponding operation or a generic-purpose processor (for example, a CPU or an application processor) which is capable of perform the operations by executing one or more software programs stored in a memory device.

The terms used in this specification are merely used to describe a specific embodiment, but do not intend to limit the scope of another embodiment. A singular form may include a plural form if there is no clearly opposite meaning in the context. Terms used herein including technical or scientific terms may have the same meaning as commonly understood by those skilled in the art. Among the terms used in this specification, terms defined in the general dictionary may be interpreted as having the same or similar meaning as the meaning in the context of the related art, but is not ideally or excessively interpreted to have formal meanings unless clearly defined in this specification. In some cases, even though the terms are defined in this specification, the terms are not interpreted to exclude the embodiments of the present specification.

The features of various embodiments of the present disclosure can be partially or entirely bonded to or combined with each other and can be interlocked and operated in technically various ways understood by those skilled in the art, and the embodiments can be carried out independently of or in association with each other.

For clarity of interpretation of the present specification, terms used in the present specification will be defined below.

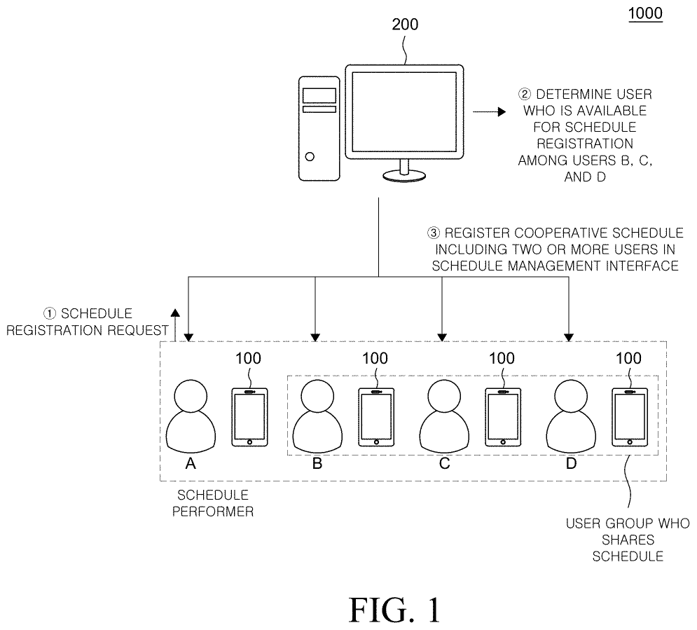

FIG. 1 is a schematic view of a multi-party schedule management system according to an exemplary embodiment of the present disclosure.

Referring to FIG. 1, a multi-party schedule management system 1000 may include a plurality of user devices 100 and a server 200 (hereinafter, a schedule management server) providing a user interface for multi-party schedule management to the user device 100.

The multi-party schedule management system 1000 may provide users individual schedules to a user group who shares the schedule to be checked at a glance. Specifically, the multi-party schedule management system 1000 may provide a schedule management interface that individual schedules are arranged by means of a schedule management application installed or executed in the user device 100. According to the request of each user, the multi-party schedule management system 1000 may update a schedule displayed on the schedule management interface.

The plurality of user devices 100 is electronic devices capable of executing a schedule management application provided by the schedule management server 200 and may include smartphones, tablet PCs, PCs, or notebook computers. The user device 100 may transmit a schedule registration request to the schedule management server 200. Here, the schedule registration request may include date, time, a schedule performer, a schedule type (category), and additional explanation according to the schedule type.

According to various exemplary embodiments, the multi-party schedule management system 1000 may manage an individual schedule including only one user and a cooperative schedule that two or more users are included. Specifically, the cooperative schedule may be defined as a schedule that a user who performs the schedule and a user who participates in the schedule are included. The cooperative schedule may be basically configured by one schedule performer and one schedule participant and if necessary, configured by a plurality of schedule participants. In the cooperative schedule, the schedule participant may start or end the schedule together with the schedule performer. If the schedule participant cannot start and end the schedule together with the schedule performer due to a previously set individual schedule, another schedule participant may be further included.

For example, when a user A wants to register a new schedule in the schedule management server 200 by means of a schedule management interface that is output to the user device 100, the schedule management server 200 may check whether the schedule is an individual schedule or a cooperative schedule. If the new schedule is a cooperative schedule, the schedule management server 200 may determine a user who is available for schedule registration, among users B, C, and D in a user group who shares the schedule. The schedule management server 200 may register the cooperative schedule including the schedule performer together with a determined user (schedule participant) in the schedule management interface.

In the meantime, in FIG. 1, it has been described that a user who requests the registration of the new schedule and a schedule performer are the same user, in some cases, the user who requests the registration of the new schedule and the schedule performer may be different users. That is, a user in the user group who shares the schedule may select an empty schedule region on the schedule management interface that the individual schedule and the cooperative schedule are registered and register a schedule of the other party.

The multi-party schedule management system 1000 may manage the cooperative schedule and the individual schedule by means of the schedule management server 200. The schedule management server 200 may manage schedules of a plurality of user groups. For example, according to the request of the user device 100, the schedule management server 200 may register the individual schedule or the cooperative schedule related to the user in the schedule management interface. Here, the schedule management interface may be a schedule management interface of a group that the user belongs. The schedule management server 200 may receive a cooperative schedule registration request from another user who does not belong to the user group. In this case, the cooperative schedule registration request may include identification information of the schedule performer. The schedule management server 200 may transmit a notification for the cooperative schedule registration request to the user group including the schedule performer.

Until now, the multi-party schedule management system 1000 according to the exemplary embodiment of the present disclosure has been described. Hereinafter, the user device 100 executing a schedule management application to manage schedules of individual users will be described.

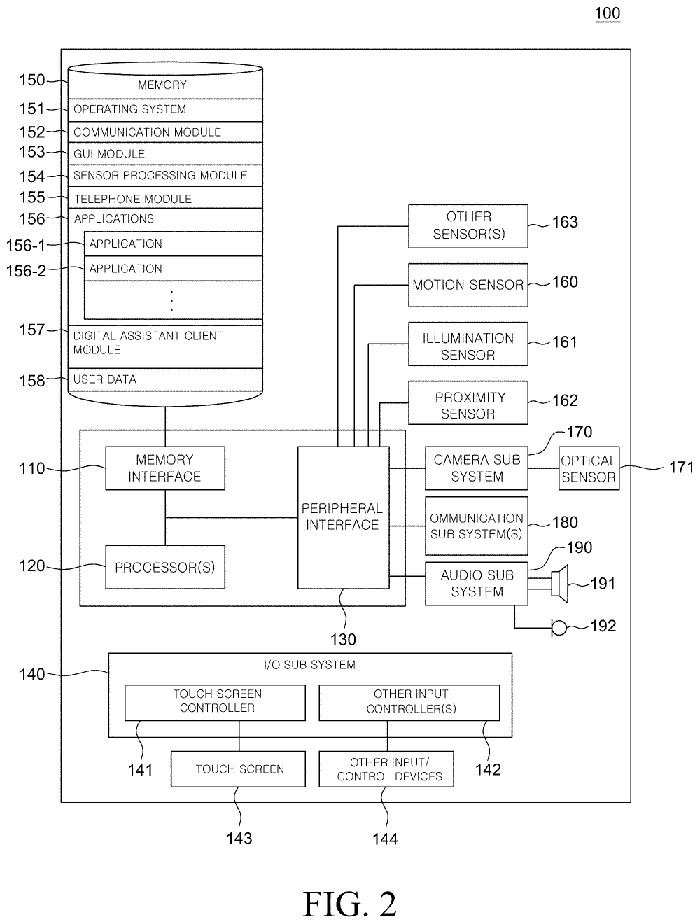

FIG. 2 is a block diagram illustrating a configuration of a user device according to an exemplary embodiment of the present disclosure.

Referring to FIG. 2, the user device 100 may include a memory interface 110, one or more processors 120, and a peripheral interface 130. Various components in the user device 100 may be connected by one or more communication buses or signal lines.

The memory interface 110 is connected to a memory 150 to transmit various data to the processor 120. Here, the memory 150 may include at least one type of storing media of a flash memory type, a hard disk type, a multimedia card micro type, a card type memory (for example, an SD or XD memory), a RAM, an SRAM, a ROM, an EEPROM, a PROM, a network storage, a cloud, and a block chain database.

In various exemplary embodiments, the memory 150 may store at least one of an operating system 151, a communication module 152, a graphic user interface module (GUI) 153, a sensor processing module 154, a telephone module 155, and an application 156. Specifically, the operating system 151 may include a command for processing a basic system service and a command for performing hardware tasks. The communication module 152 may communicate with at least one of the other devices, computers, and servers. The graphic user interface module (GUI) 153 may process a graphic user interface. The sensor processing module 154 may process sensor related functions (for example, processing a received voice input using one or more microphones 192). The telephone module 155 may process telephone related functions. The application module 156 may perform various functions of the user application, such as electronic messaging, web browsing, media processing, searching, imaging, or other processing functions. Further, the user device 100 may store one or more software applications 156-1 and 156-2 (for example, a schedule management application) related to any one type of services in the memory 150.

In various exemplary embodiments, the memory 150 may store a digital assistant client module 157 (hereinafter, simply referred to as a DA client module) and accordingly, may store commands for performing a function of the client of the digital assistant and various user data 158 (for example, other data such as user customized vocabulary data, preference data, a user electronic address book, a to-do list, or a shopping list).

In the meantime, the DA client module 157 may acquire voice input, text input, touch input and/or gesture input of the user by means of various user interfaces (for example, I/O sub system 140) equipped in the user device 100.

Further, the DA client module 157 may output audio-visual or tactile data. For example, the DA client module 157 may output data formed of a combination of at least two or more of voice, sound, a notice, a text message, a menu, a graphic, a video, an animation, and a vibration. Further, the DA client module 157 may communicate with a digital assistant server (not illustrated) using a communication sub system 180.

In various exemplary embodiments, the DA client module 157 may collect additional information about the surrounding environment of the user device 100 from various sensors, sub systems, and peripheral devices to configure a context associated with the user input. For example, the DA client module 157 may infer the intention of the user by providing context information to the digital assistant server together with the user input. Here, the context information may be companied by the user input may include sensor information, such as light, ambient noises, ambient temperature, an image of the surrounding environment, and a video. As another example, the context information may include a physical state (for example, a device alignment, a device position, a device temperature, a power level, a speed, an acceleration, a motion pattern, or a cellular signal intensity) of the user device 100. As another example, the context information may include information related to a software state of the user device 100 (for example, a process which is being executed, installed program, past and present network activities, a background service, an error log, or resource usage in the user device 100).

According to various exemplary embodiments, the memory 150 may include added or deleted commands and further, the user device 100 may also include additional configurations other than the configurations illustrated in FIG. 2 or exclude some configurations.

The processor 120 may control an overall operation of the user device 100 and run an application or a program stored in the memory 150 to perform various commands to implement a schedule management interface.

The processor 120 may correspond to an arithmetic device such as a central processing unit (CPU) or an application processor (AP). Further, the processor 120 may be implemented as an integrated chip (IC) such as a system on chip (SoC) that various arithmetic devices, such as a neural processing unit (NPU), are integrated.

In various exemplary embodiments, the processor 120 acquires schedule registration request information related to the user and may register the corresponding schedule in the schedule management interface according to a type of the schedule registration request. Here, the type of the schedule registration request may be classified into an individual schedule and a cooperative schedule of a user. For example, the processor 120 checks a schedule performer of the individual schedule and if the schedule performer is a schedule registration requester, may immediately register the individual schedule in the schedule management interface. In contrast, if the schedule performer is not a schedule registration requester, the processor 120 transmits a confirmation notification for the individual schedule to the user device 100. The processor 120 may register the corresponding individual schedule according to a result of confirmation through the corresponding user. As another example, the processor 120 confirms a schedule performer and a number of the schedule participants of the cooperative schedule. The processor 120 may determine available schedule participants for the cooperative schedule based on the confirmed number of schedule participants. Here, the method for determining a schedule participant may be performed by the schedule management server 200 or determined by the user device 100. A detail description thereof will be provided after.

The peripheral interface 130 is connected to various sensors, sub systems, and peripheral devices to provide data to allow the user device 100 to perform various functions. Here, when the user device 100 performs any function, it is understood that the function is performed by a processor 120.

The peripheral interface 130 may receive data from a motion sensor 160, an illumination sensor (an optical sensor) 161, and a proximity sensor 162 and by doing this, the user device 100 may perform alignment, lighting, and proximity sensing functions. As another example, the peripheral interface 130 may be provided with data from other sensors 163 (a positioning system-GPS receiver, a temperature sensor, or a biometric sensor) and by doing this, the user device 100 may perform functions related to the other sensors 163.

In various exemplary embodiments, the user device 100 may include a camera sub system 170 connected to the peripheral interface 130 and an optical sensor 171 connected thereto and by doing this, the user device 100 may perform various photographing functions such as taking a picture or recording a video clip.

In various exemplary embodiments, the user device 100 may include a communication sub system 180 connected to the peripheral interface 130. The communication sub system 180 is configured by one or more wired/wireless networks and may include various communication ports, a wireless frequency transceiver, and an optical transceiver.

In various exemplary embodiments, the user device 100 includes an audio sub system 190 connected to the peripheral interface 130 and the audio sub system 190 includes one or more speakers 191 and one or more microphones 192 so that the user device 100 may perform voice-operated functions, such as voice recognition, voice duplication, digital recording, and telephone functions.

In various exemplary embodiments, the user device 100 may include an I/O sub system 140 connected to the peripheral interface 130. For example, the I/O sub system 140 may control the touch screen 143 included in the user device 100 by means of a touch screen controller 141. For example, the touch screen controller 141 may use any one of a plurality of touch sensing techniques such as a capacitive type, a resistive type, an infrared type, a surface acoustic wave technology, or a proximity sensor array to detect contact and movement of the user or stopping of contact and movement. As another example, the I/O sub system 140 may control the other input/control device 144 included in the user device 100 by means of other input controller(s) 142. As an example, other input controller(s) 142 may control one or more buttons, rocker switches, thumb-wheels, infrared ports, USB ports, and pointer devices such as a stylus.

Until now, the user device 100 according to the exemplary embodiment of the present disclosure has been described. Hereinafter, a schedule management server 200 providing a schedule management application and a schedule management service and manages a cooperative schedule in a user group will be described.

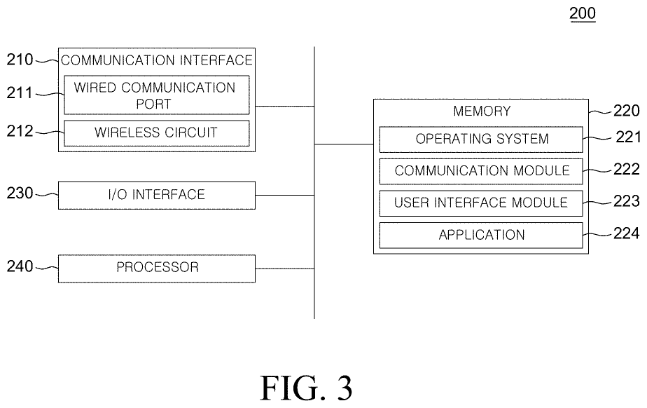

FIG. 3 is a block diagram illustrating a configuration of a schedule management server providing a user interface according to an exemplary embodiment of the present disclosure.

Referring to FIG. 3, the schedule management server 200 may include a communication interface 210, a memory 220, an I/O interface 230, and a processor 240 and each configuration may communicate with each other via one or more communication buses or signal lines.

The communication interface 210 is connected to a plurality of user devices 100 via a wired/wireless communication network to exchange data. For example, the communication interface 210 may receive the schedule registration request from the user device 100 or a third-party device (not illustrated). Here, the third-party device may be a device possessed by a user who does not belong to the user group, but provides an individual schedule and a cooperative schedule assigned to a user who uses the schedule management service. For example, the third-party device may be a device possessed by a private institute, a shuttle bus company, or an instructor with a designated time table.

As another example, the communication interface 210 determines a user to be registered for the schedule according to the type of the schedule registration request. The communication interface 210 may transmit the determination result to the user device 100.

In the meantime, the communication interface 210 that enables the transmission/reception of the data includes a wired communication port 211 and a wireless circuit 212 and the wired communication port 211 may include one or more wired interfaces, such as Ethernet, universal serial bus (USB), and fire wire. Further, the wireless circuit 212 may transmit and receive data with external devices by an RF signal or an optical signal. In addition, the wireless communication may use at least one of a plurality of communication standards, protocols, and technologies, such as GSM, EDGE, CDMA, TDMA, Bluetooth, Wi-Fi, VoIP, Wi-Max, or other arbitrary appropriate communication protocols.

The memory 220 may store various data used in the schedule management server 200. For example, the memory 220 may store data constituting a schedule management interface and a schedule registration interface. Also, the memory 220 may store a type of a schedule category for every user group, a number of schedule participants for every type, user group identification information, user identification information, individual schedules and a cooperative schedule in the user group.

In various exemplary embodiments, the memory 220 may include a volatile or nonvolatile recording medium capable of storing various data, commands, and information. For example, the memory 220 may include at least one type of storage media of a flash memory type, a hard disk type, a multimedia card micro type, a card type memory (for example, an SD or XD memory), a RAM, an SRAM, a ROM, an EEPROM, a PROM, a network storage, a cloud, and a block chain database.

In various exemplary embodiments, the memory 220 may store a configuration of at least one of an operating system 221, a communication module 222, a user interface module 223, and one or more applications 224.

The operating system 221 (for example, an embedded operating system, such as LINUX, UNIX, MAC OS, WINDOWS, VxWorks) may include various software components and drivers that control and manage a general system task (for example, memory management, storage device control, or power management) and support communication between various hardware, firmware, and software components.

The communication module 223 may support communication with other device through the communication interface 210. The communication module 220 may include various software components for processing data received by a wired communication port 211 or a wireless circuit 212 of the communication interface 210.

The user interface module 223 may receive a request or an input of the user from a keyboard, a touch screen, or a microphone via the I/O interface 230 and provide the user interface on the display.

The application 224 may include a program or a module configured to be executed by one or more processors 230. Here, the application for providing the schedule management service may be performed on a server farm.

The I/O interface 230 may connect at least one of input/output devices (not illustrated) of the schedule management server 200, such as a display, a keyboard, a touch screen, and a microphone, to the user interface module 223. The I/O interface 230 receives the user input (for example, voice input, keyboard input, or touch input) together with the user interface module 223 and processes a command in accordance with the received input.

The processor 240 is connected to the communication interface 210, the memory 220, and the I/O interface 230 to control an overall operation of the schedule management server 200 and may perform various commands to systematically manage the individual schedules of the plurality of user groups by the application or the program stored in the memory 220.

The processor 240 may correspond to an arithmetic device such as a central processing unit (CPU) or an application processor (AP). Further, the processor 240 may be implemented as an integrated chip (IC) such as a system on chip (SoC) that various arithmetic devices are integrated. Further, the processor 240 may include a module for calculating an artificial neural network model like a neural processing unit (NPU).

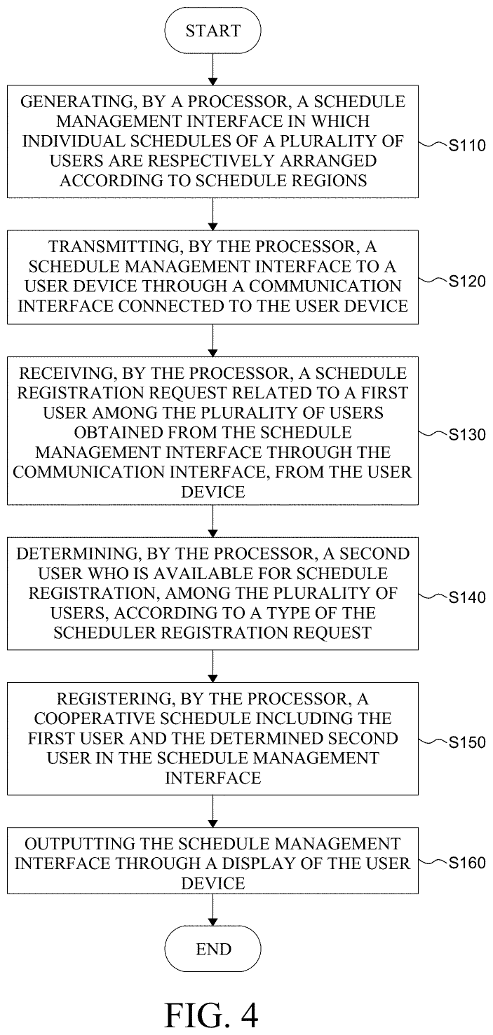

In various exemplary embodiments, the processor 240 may automatically make the schedules of the users to register a schedule including two or more users. Hereinafter, it will be described with reference to FIGS. 4 to 8.

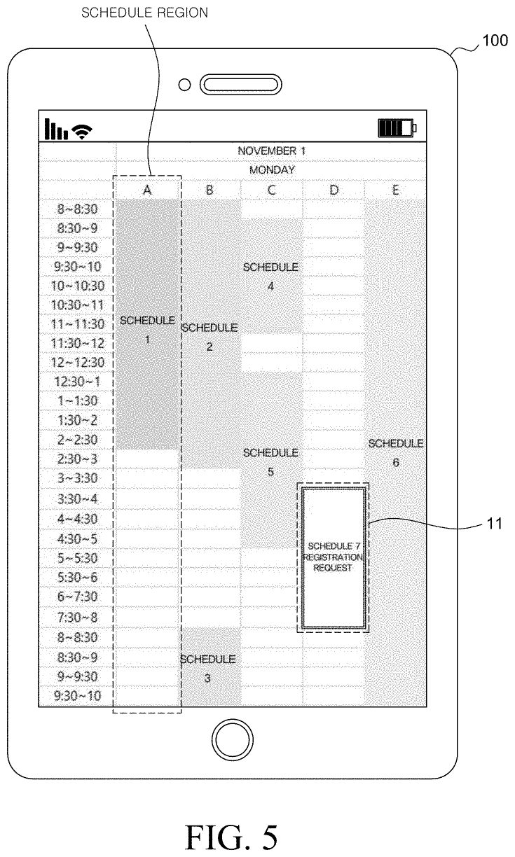

FIG. 4 is a flowchart for a user interface providing method according to an exemplary embodiment of the present disclosure and FIGS. 5 to 8 are schematic views for explaining a user interface screen for multi-party schedule management according to an exemplary embodiment of the present disclosure.

Referring to FIGS. 4 and 5, the processor 240 may generate a schedule management interface in which individual schedules of a plurality of users are respectively arranged according to schedule regions in S110. The processor 240 may transmit a schedule management interface to a user device 100 through a communication interface 210 connected to the user device 100 in S120. Specifically, the schedule management interface may include a schedule region of each of the plurality of users and an individual schedule arranged in the schedule region. For example, the schedule regions and the individual schedules may be arranged in parallel with respect to the time. The user group who shares the schedule may check the schedules of the users on one interface screen by means of the user device 100.

In the meantime, in the schedule management interface of FIG. 5, each schedule is illustrated with a 30-minute interval, but the time interval may be differently specified to one minute to one hour, depending on the time setting in the user group.

After the step S120, the processor 240 may receive a schedule registration request related to the first user, among the plurality of users obtained from the schedule management interface through the communication interface 210, from the user device 100 in S130. Specifically, the schedule registration request may include at least one schedule performance item, among a start time, an end time, a start location, an arrival location, and moving means of the schedule.

In various exemplary embodiments, the processor 240 may receive the schedule registration request from a user device 100 of a first user or another user device 100 in a user group that the first user belongs, by means of the communication interface 210. For example, any one user in the user group who shares the schedule, selects (ex. Continuously drags 11) any one region among empty regions available for schedule registration, in the schedule management interface, and may input schedule information to be registered in the selected region by means of the user device 100.

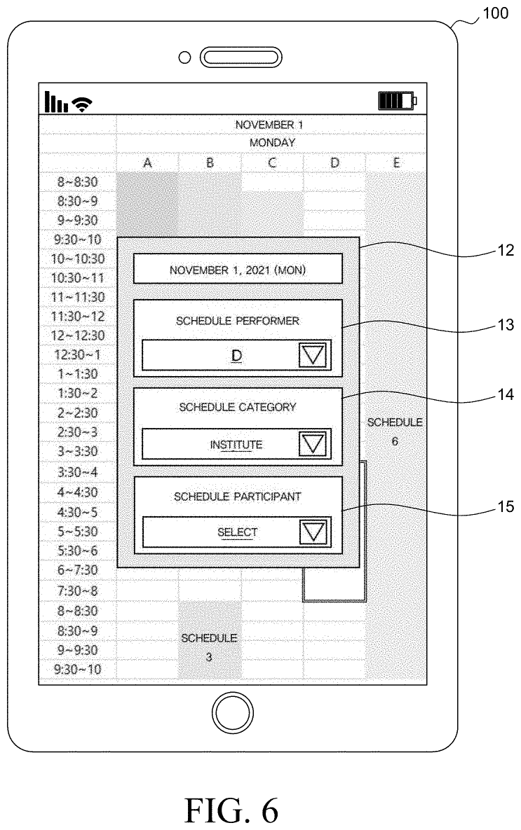

In various exemplary embodiments, as the user selects an empty region in the schedule management interface, the processor 240 may transmit the schedule registration interface 12 to the user device 100 through the communication interface 210 as illustrated in FIG. 6. Specifically, the schedule registration interface may include a first user input region 13 performing the schedule and a schedule category selection region 14. Here, the first user refers to any one schedule performer in the user group who shares the schedule. The schedule category may refer to a category for determining a type of a schedule registration request (individual schedule/cooperative schedule). That is, a category for determining whether a schedule participant is necessary. For example, when a schedule category is an institute requiring pick-up, the processor 240 may determine that a second user (schedule participant) for a first user who is a schedule performer is necessary. As another example, when the schedule category is distance learning, the processor 240 may determine that a second user for the first user who is a schedule performer is not necessary.

If the second user (schedule participant) is necessary in accordance with the selection of the schedule category, the processor 240 may additionally provide a region 15 for selecting the second user (schedule participant) by means of the schedule registration interface 12. By doing this, the user may select to directly specify the second user or allow the processor 240 to automatically determine the second user.

In the meantime, the type of the schedule category determining whether the second user is necessary may be differently set for every user group to be stored in the memory 220. By doing this, a second user appropriate for the schedule is automatically allocated to the schedule that is frequently registered so that the users may manage the individual schedules without selecting the necessity of the second user.

In various exemplary embodiments, the processor 240 may further provide a region for inputting a location where the schedule is performed, to the schedule registration interface 12. For example, the location input region refers to a region for searching for a specific location such as “AA institute” or “OOO GC” and the processor 240 may determine whether the second user is necessary based on information set in advance for the location.

In various exemplary embodiments, the processor 240 may receive a schedule related to any one user, among the plurality of users, from a device of the third party, by means of the communication interface 210. Specifically, the third party may be a user who does not belong to the user group, but provide individual schedule and a cooperative schedule assigned to a user who uses the schedule management service, for example, an institute operator or an instructor. For example, the processor 240 may receive a schedule of the user or a specific individual schedule or a cooperative schedule, together with identification information corresponding to any one user in the user group, from the third party device, by means of the communication interface 120. The processor 240 may receive whether the schedule is confirmed from the user device 100 of the corresponding user through the communication interface 210. The processor 240 may register the confirmed schedule in the schedule management interface output through a display (ex. The touch screen 143) of the user device 100.

After the step S130, the processor 240 may determine a second user who is available for the schedule management, among the plurality of users, according to the type of the schedule registration request in S140. The type of the schedule registration request may be classified into an individual schedule of a user and a cooperative schedule. The processor 240 may check what type of schedule the user wants to register, according to the direct request or the selection of the schedule category of the user.

As a checking result, if it is a cooperative schedule, the processor 240 may determine a user who is available for the schedule registration, based on at least one schedule performance item, among a start time, an end time, a start location, an arrival location, and a moving means of the requested schedule.

That is, the processor 240 checks the schedules of the remaining users, other than the first user (a schedule performer), among the plurality of users. The processor 240 may determine a second user who has an empty region to register the cooperative schedule as a user who is available for the schedule registration.

Further, the processor 240 may determine a schedule participant (second user) based on the start time of the cooperative schedule. The processor 240 may determine whether the schedule participant (second user) can be together even at the end time. If the schedule participant cannot be together at the start and the end of the schedule due to the previously set individual schedule of the schedule participant (second user), the processor 240 may determine two schedule participants (second users).

In various exemplary embodiments, the processor 240 may check the locations of the users based on the individual schedules of the remaining users. The processor 240 may determine whether each of the plurality of users is available for the schedule registration with respect to the checked locations. For example, the processor 240 checks the start location or the end location together with the end time of the individual schedule. In addition, the processor 240 checks the start location/start time or the end location/end time of the cooperative schedule to determine whether to perform the cooperative schedule.

In various exemplary embodiments, if there are two or more users who are available for the schedule registration, the processor 240 may transmit a list for selecting users who are available for the schedule registration to the user device 100 through the communication interface 210. In addition, the processor 240 may transmit a cooperative schedule acceptance notification to two or more user devices 100 capable of registering the schedule registration by means of the communication interface 210. The processor 240 may determine a user who accepts the cooperative schedule first as a user to be included in the cooperative schedule.

If there is no user who is available for the schedule registration, the processor 240 may generate a notification for recruiting the second user. Specifically, the processor 240 may acquire identification information of the user group during the process of transmitting a schedule management interface for every user group. For example, the identification information may include an age of the user group, a purpose of establishing the schedule management (for example, child care or club meeting), and a main position of the user group. The processor 240 may group the user groups according to types of the identification information. Thereafter, the processor 240 may generate and transmit the notification for recruiting the second user to the plurality of user devices 100 in the corresponding group depending on the necessity of the cooperative schedule through the communication interface 210.

After the step S140, the processor 240 may register the cooperative schedule including the first user and the second user who is previously determined in the schedule management interface in S150. The processor 240 may output the schedule management interface through a display of the user device 100 in S160. Further, the processor 240 may transmit the schedule registration notification to each of the user devices 100 of two or more users through the communication interface 210. Here, the schedule registration notification may include content of at least one schedule performance item, among a start time, an end time, a start location, an arrival location, and moving means of the schedule.

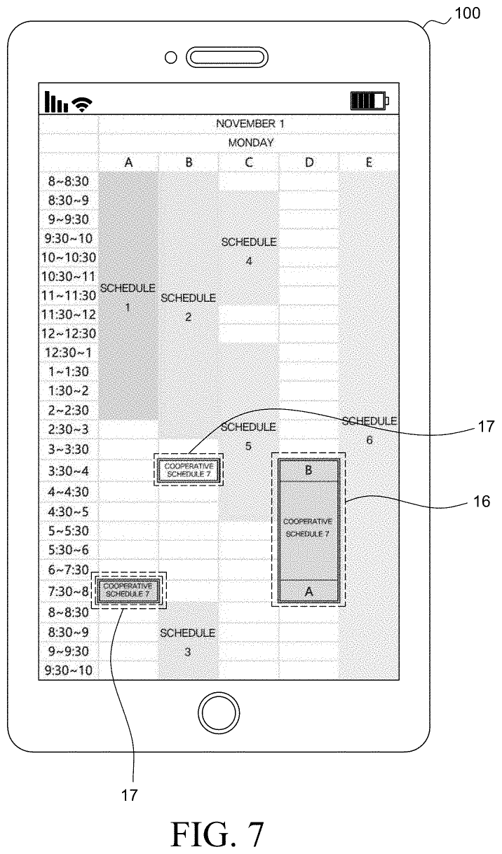

With regard to this, referring to FIG. 7, in the schedule management interface, as the cooperative schedule, a performance schedule 16 of the first user or a participation schedule 17 of the second user may be arranged in schedule regions of the first and second users. Here, the participation schedule 17 of the second user may overlap a predetermined time interval of the performance schedule 16 of the first user based on the schedule.

In various exemplary embodiments, the processor 240 may determine a predetermined time interval for registering the participation schedule 17 of the second user, based on the schedule performance item. Specifically, the processor 240 checks at least one item of the start time, the end time, and the arrival location of the schedule together with the moving means to calculate a time to be taken to participate in the corresponding schedule. The processor 240 may determine the calculated time as a predetermined time. For example, when a time to arrive a designated location by bicycle is 15 minutes, a time allocated to the participation schedule 17 of the second user in the schedule region of the second user may be determined as 15 minutes.

That is, the processor 240 may arrange the start time (ex. A participation schedule start point of a user B) of the participation schedule 17 in the schedule region of the second user to be equal to the start point (ex. A performance schedule start point of a user D) of the performance schedule 16 in the schedule region of the first user. Or, the processor 240 may arrange the end point (ex. A participation schedule end point of the user B) of the participation schedule 17 in the schedule region of the second user to be equal to the end point (ex. A performance schedule end point of the user D) of the performance schedule 16 in the schedule region of the first user.

In addition, in the case of the cooperative schedule, in the schedule management interface, the second user (the schedule participant) may be illustrated on the performance schedule 16. Accordingly, the schedule performer may confirm which user of the plurality of users is together at a glance by means of the schedule management interface.

In various exemplary embodiments, a schedule including two or more user may be displayed as different images in the schedule management interface based on a moving means for the schedule or the user included in the schedule. For example, the processor 240 may display different cooperative schedule images on the schedule interface depending on whether the moving means is walking or a shuttle bus. The processor 240 may display different cooperative schedule images depending on the schedule participant. Here, the difference of the images may be displayed by a font, a size, a color of the letters representing the schedule, a thickness of the schedule start line/end line.

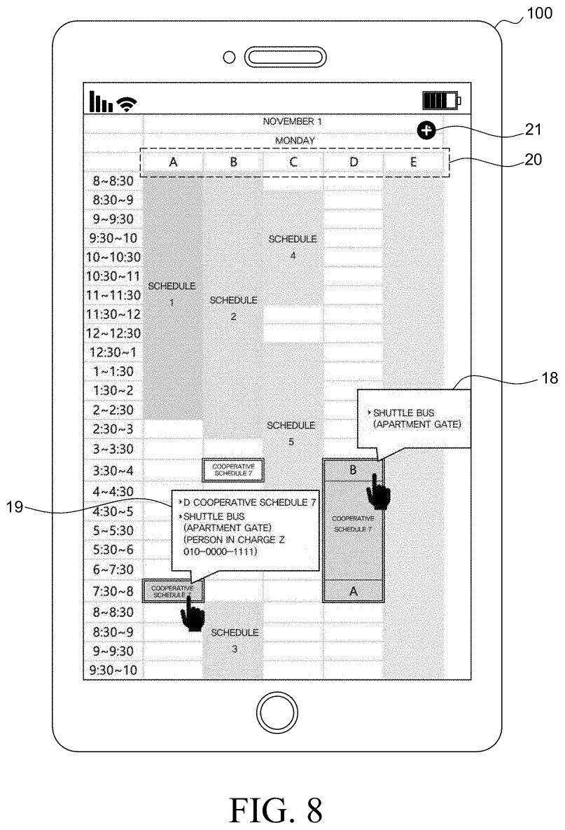

In various exemplary embodiments, as the user selects the cooperative schedule of the schedule management interface, the processor 240 may transmit information related to the cooperative schedule performance to the user device 100 through the communication interface 210. Specifically, as illustrated in FIG. 8, the processor 240 may provide different information 18 and 19 for every schedule performer and schedule participant of the cooperative schedule as the user selects the cooperative schedule. For example, the processor 240 may provide the moving means and the start location information 18 to the schedule performer. The processor 240 may provide additional information 19 related to the schedule performance, such as a schedule performer, a moving means, a start location, and contact information of a person in charge, and specific information (link) regarding the schedule location, to the schedule participant.

In various exemplary embodiments, as the user selects the individual schedule of the schedule management interface, the processor 240 may transmit a schedule related notification designated by the schedule registration user on the individual schedule to the user device 100 through the communication interface 210. Here, the notification may be a text that information related to the schedule is described or a simple image icon.

In various exemplary embodiment, as the user selects any one user in the user list 20 of the schedule management interface, the processor 240 may transmit a notice or additional information designated by the users to the user device 100 through the communication interface 210. Further, as the additional icon 21 of the schedule management interface is selected, a new user may be added to the user group who shares the schedule or a new schedule may be added. For example, the new user may be a guest user with limited schedule management. The guest user may be a user who cannot transmit a schedule registration request related to the user, but may participate in the cooperative schedule.

Until now, the schedule management server 200 according to the exemplary embodiment of the present disclosure has been described. According to the present disclosure, the users may intuitively check the multi-party schedule by means of the schedule management interface output through the display of the user device 100 provided by the schedule management server 200 to more conveniently manage a schedule that two or more users need to participate and when a schedule requiring two or more users is registered, simply register the schedule with a user who may perform the schedule together, based on the recommendation from the schedule management server 200.

Although an exemplary embodiment of the present disclosure has been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but not intended to limit the technical concept of the present disclosure. The scope of the technical concept of the present disclosure is not limited thereto. Therefore, it should be understood that the above-described exemplary embodiments are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A method of providing a user interface in user device for multi-party schedule management, the method comprising:
generating, by a processor, a schedule management interface in which individual schedules of a plurality of users are respectively arranged according to schedule regions;
transmitting, by the processor, a schedule management interface to a user device through a communication interface connected to the user device;
receiving, by the processor, a schedule registration request related to a first user among the plurality of users obtained from the schedule management interface through the communication interface, from the user device;
determining, by the processor, a second user who is available for schedule registration, among the plurality of users, according to a type of the scheduler registration request;
registering, by the processor, a cooperative schedule including the first user and the determined second user in the schedule management interface; and
outputting the schedule management interface through a display of the user device.

2. The user interface providing method for multi-party schedule management according to claim 1, wherein the schedule management interface, includes the schedule region of each of the plurality of users and an individual schedule disposed in the schedule region, and
wherein, as the cooperative schedule, a performance schedule of the first user or a participation schedule of the second user is arranged in the schedule regions of the first and second users.

3. The user interface providing method for multi-party schedule management according to claim 2, wherein the participation schedule of the second user overlaps a predetermined time interval of the performance schedule of the first user based on the schedule.

4. The user interface providing method for multi-party schedule management according to claim 3, wherein in the schedule management interface, a start point of the participation schedule in a schedule region of the second user is disposed to be equal to a start point of the performance schedule in the schedule region of the first user or an end point of the participation schedule in the schedule region of the second user is disposed to be equal to an end point of the performance schedule in the schedule region of the first user.

5. The user interface providing method for multi-party schedule management according to claim 2, wherein in the schedule management interface, schedules including two or more users are displayed with different images based on a moving means for the schedule or a user included in the schedule.

6. The user interface providing method for multi-party schedule management according to claim 2, wherein the schedule management interface, displays a schedule related notification designated by a schedule registration user on the individual schedule.

7. The user interface providing method for multi-party schedule management according to claim 1, wherein the schedule registration request includes at least one schedule performance item, among a start time, an end time, a start location, an arrival location, and moving means of the schedule and the determining of a user is a step of determining, by the processor, a user available for the schedule registration based on the schedule performance item.

8. The user interface providing method for multi-party schedule management according to claim 7, further comprising:
transmitting, by the processor, a list for selecting a user who is available for the schedule registration to the user device through the communication interface when there are two or more users who are available for the schedule registration.

9. The user interface providing method for multi-party schedule management according to claim 7, wherein the determining of a user further includes:
checking, by the processor, a location of each of the plurality of users based on the individual schedules and determining, by the processor, whether each of the plurality of users is available for the schedule registration based on the checked location.

10. The user interface providing method for multi-party schedule management according to claim 1, wherein the receiving of a schedule registration request further includes:
transmitting, by the processor, a schedule registration interface to the user device through the communication interface, and
the schedule registration interface includes an input region of a first user who performs the schedule and a schedule category selection region.

11. The user interface providing method for multi-party schedule management according to claim 10, wherein the receiving of a schedule registration request further includes:
determining, by the processor, whether a second user is necessary depending on a type of the schedule category.

12. The user interface providing method for multi-party schedule management according to claim 1, further comprising:
receiving, by the processor, a schedule related to any one user among the plurality of users from a third-party device through the communication interface; and
receiving, by the processor, whether the schedule is confirmed from the user device of the corresponding user through the communication interface, registering, by the processor, the confirmed schedule in the schedule management interface.

13. The user interface providing method for multi-party schedule management according to claim 1, wherein the registering in the schedule management interface further includes:
transmitting, by the processor, a schedule registration notification to each of user devices of two or more users through the communication interface.

14. A server for providing a user interface in user device for multi-party schedule management, the server comprising:
a communication interface;
a memory; and
a processor that is operably connected to the communication interface and the memory,
wherein the processor is configured to generate a schedule management interface in which individual schedules of a plurality of users are respectively arranged according to schedule regions,
transmit a schedule management interface to a user device through a communication interface connected to the user device, receive a schedule registration request related to a first user among the plurality of users obtained from the schedule management interface through the communication interface, from the user device, determine a second user who is available for the schedule registration, among the plurality of users, according to a type of the scheduler registration request, register a cooperative schedule including the first user and the determined second user in the schedule management interface, and output the schedule management interface through a display of the user device.

15. The user interface providing server for multi-party schedule management according to claim 14, wherein the schedule management interface, includes the schedule region of each of the plurality of users and an individual schedule disposed in the schedule region, and in the cooperative schedule, a performance schedule of the first user and a participation schedule of the second user are arranged in schedule regions of the first and second users.

16. The user interface providing server for multi-party schedule management according to claim 15, wherein the participation schedule of the second user overlaps a predetermined time interval of the performance schedule of the first user based on the schedule.

17. The user interface providing server for multi-party schedule management according to claim 16, wherein in the schedule management interface, a start point of the participation schedule in a schedule region of the second user is disposed to be equal to a start point of the performance schedule in the schedule region of the first user or an end point of the participation schedule in the schedule region of the second user is disposed to be equal to an end point of the performance schedule in the schedule region of the first user.

18. The user interface providing server for multi-party schedule management according to claim 14, wherein the schedule registration request includes at least one schedule performance item, among a start time, an end time, a start location, an arrival location, and moving means of the schedule and the processor is configured to determine a user who is available for the schedule registration based on the schedule performance item.

19. The user interface providing server for multi-party schedule management according to claim 14, wherein the processor is configured to transmit a schedule registration interface to the user device outputable through the display of the user device to the user device through the communication interface, and the schedule registration interface includes an input region of a first user who performs the schedule and a schedule category selection region.

20. The user interface providing server for multi-party schedule management according to claim 19, wherein the processor is configured to determine whether the second user is necessary depending on the type of the schedule category.
